(19) United States
(12) Patent Application Publication
(10) Pub. No.: US 2011/0045146 A1
(43) Pub. Date: Feb. 24, 2011

(54) Gluten free and/or dairy free cookie dough

(76) Inventors: Moira Deneen Canty, Rockville Centre, NY (US); Megan Deneen Moran, Rockville Centre, NY (US)

Correspondence Address: WEISS & WEISS;Suite 251, 300 Old Country Road, Mineola, NY, 11501, US

(21) Appl. No.: 12/583,534

(22) Filed: Aug. 20, 2009

(51) Int. Cl. A21D 13/00; A21D 2/02; A23G 1/32; A21D 10/02

(52) U.S. Cl. 426/94; 426/551; 426/517

(57) ABSTRACT

Adapting to the gluten free and/or casein free and lactose free diet requires some lifestyle changes. The present invention is a gluten free and/or casein free, and lactose free baked food. The invention utilizes a flour mixture of white rice flour, potato starch, tapioca flour, xanthum gum or any combination to create a pre-packaged, ready to bake cookie dough, with good taste and texture similar to currently marketed wheat flour containing cookies which are ready to bake.

### FIELD OF THE INVENTION

The present invention relates to a cookie dough that is gluten and/or casein and lactose free.

### BACKGROUND OF THE INVENTION

The known benefits of a gluten free, dairy free diet for many people are on the rise. Specifically, individuals may be adversely affected by consuming even small amounts of gluten, a protein found in wheat, rye, barley and spelt, and/or casein, a protein found in dairy products. Lactose, a sugar found in dairy, has long been recognized as problematic as well for some individuals.

Celiac disease affects children as well as adult men and women. It is a lifelong digestive disorder triggered by eating gluten proteins found in wheat, rye and barley. Symptoms vary and are not always gastrointestinal. Awareness and diagnosis are on the rise. Researchers say 1 in 133 people are affected by celiac disease in the United States and 1 in 100 in Western England.

Celiac disease is an autoimmune disorder that runs in families. When an affected individual consumes wheat, barley or rye, the immune system reacts to the protein (gluten) present in the food and begins to attack itself, ultimately damaging the lining of the small intestine where nutrients are absorbed, leading to symptoms and further disease. The only treatment for this autoimmune disease is a lifelong adherence to a diet completely devoid of gluten. Left untreated, individuals with the disease are at increased risk for cancer, malnutrition and additional autoimmune diseases such as lupus. Celiac disease is one of the most common and most under diagnosed autoimmune conditions in the country today. There are currently no drugs yet developed to treat celiac disease and there is no cure but celiacs can lead normal healthy lives following a gluten free diet. Dietary compliance increases the quality of life and decreases the likelihood of osteoporosis, intestinal lymphoma and other associated illnesses.

Many children today are improving from Autism because of the many different interventions. One of the most important aspects of recovery for many of these children is following a gluten/casein free diet. Types of foods that need to be decreased are gluten and casein products. When these children's diets are changed, many of the children with autism seem to respond. Gluten and casein play a role in development of opiate peptides which may affect brain function, development and socialization skills. These skills are needed for simple daily functions and affect a child from realizing their true potential in life activities. Gluten and casein amino acid chains are partially broken down into neurotransmitters that act like opiates (morphine like substances) in these children's brains. The Autism Research Institute and other advocacy groups recommend gluten/casein free diets as a treatment for Autism and related disorders.

Parents have more power to control and learn about nutrition, and are learning about what foods to avoid in order to improve functional attention. Many children can benefit from removing allergen prone foods. Children with different kinds of attention difficulties have hypersensitivities to foods such as the proteins (gluten) in wheat, barley and rye, and dairy. Attention difficulties such as auditory and visual distractibility, inability to sustain focus for learning and difficulty with remaining still, affect many children every day. Many American children under the age of 18 suffer from food allergies. There are reports of significant improvements of children's sleep patterns, behavior, language, focus and eye contact when allergy prone foods are removed from the diet. Following a gluten/casein free diet improves the function of many children.

Another group to consider is wheat intolerant individuals. These people do not have celiac disease, or have not yet been diagnosed, but symptoms of gluten sensitivity are usually the same. Individuals with wheat intolerances experience great improvements of symptoms when following a gluten free diet.

Those with dairy intolerances usually fall into one of two groups: either lactose intolerance or casein sensitivity. It is estimated that between 30-50 million Americans are lactose intolerant. Certain ethnic and racial populations are more affected than others. For example, almost all Asians are lactose intolerant. Lactose intolerance is the inability to digest significant amounts of lactose, the major sugar found in dairy products/milk. Lactose intolerance is caused by a shortage of the enzyme lactase, which is produced by the cells that line the small intestine. Lactase is responsible to break milk sugar into two simpler forms of sugar called glucose and galactose which are then absorbed into the blood stream. Symptoms can be controlled through diet by limiting their lactose ingestion. People differ in the amounts and types of foods they can tolerate. Researchers have identified a genetic link for lactose intolerance. Casein is one of the primary proteins in cow's milk and like lactose intolerance; individuals differ in the amount of casein they can tolerate.

US patent publication 20060222740 relates to a baked product comprising rice flour, pregelatinised rice starch and optionally modified rice starch.

U.S. Pat. No. 4,668,519 relates to a reduced calorie baked goods having a pH of from about 6.8 to 9.0. An alkaline agent and a leavening system active during baking is used to control pH and texture.

U.S. Pat. No. 4,678,672 relates to a reduced calorie cracker produced from dough which contains 25-70 percent of flour, 0-20 percent gluten, 0-10 percent fat or shortening, 5-20 percent of a water-soluble polydextrose, 0-5 percent of one or more emulsifiers, 0.5-5 percent of a leavening system comprising yeast and a carbon dioxide-releasing material, and 1.5-10 percent of a cellulosic bulking agent.

### SUMMARY OF THE INVENTION

The present invention relates to a cookie dough that meets the dietary requirements of many people by making a product that is gluten, casein and lactose free. It is an object of the present invention for the product to have the convenience and taste that many busy households desire. It is an object of the present invention to replace standard flour with a combination of white rice flour, potato starch, tapioca flour and/or xanthan gum. It is an object of the present invention for the cookie dough to be more safely consumed and enjoyed by many individuals with diagnoses such as Autism Spectrum Disorders, with food sensitivities, children with attention difficulties, celiac disease and wheat intolerances, as well as dairy intolerances.

It is an object of the present invention for the product to appeal to people having celiac disease as a tasty treat without triggering a gluten reaction. It is an object of the present invention for the product to be consumed by children and families maintaining this difficult but extremely beneficial diet for autism. It is an object of the present invention for the product to be beneficial to children due to the increasing numbers of children with diagnosed allergies. It is an object of the present invention for the product to be easy, delicious and kid-friendly.

The present invention relates to a gluten free with or without dairy cookie dough that when baked produces cookies with desirable texture, flavor and appearance. It is an object of the present invention for the product to add the ease of a pre-made, ready to bake cookie dough which meets strict dietary needs as a welcomed product.

The present invention relates to a gluten free and/or casein free and dairy free cookie that is of the slice and bake cookie. It is an object of the present invention for the product to have dairy free chocolate chips. For gluten free cookie dough only, chocolate chips containing dairy may be used in same amount.

The present invention relates to a slice and bake cookie comprising: a flour mixture, baking soda, salt, gluten free baking powder, xanthum gum, margarine (casein/gluten free), sugar, and eggs. Gluten free butter may be used in place of margarine for gluten free cookie dough only.

It is an object of the present invention for xanthum gum to be replaced with or combined with arrow root starch, guar gum, corn meal, corn starch, corn, potato, potato starch, gelatin powder, lecithin, tapioca, tapioca starch.

It is an object of the present invention for casein free/gluten free margarine to be replaced with apple sauce or other fruit purees. For gluten free only, one can use butter. Palm oil, palm fruit oil, soy bean oil, sun flower oil, coconut oil, olive oil, canola oil, grape seed oil or other shortening or oils or combination of these may be used in the gluten and/or casein and lactose free versions as well.

It is an object of the present invention that either the eggs and/or sugar in any amount can be replaced with any apple sauce, fruit puree or combinations of the above.

It is an object of the present invention for the flour mixture to comprise white rice flour. It is an object of the present invention for the flour mixture to further comprise potato starch. It is an object of the present invention for the flour mixture to further comprise tapioca flour. It is an object of the present invention for the flour mixture to further comprise xanthum gum.

It is an object of the present invention for the flour mixture to comprise any rice flour, potato starch flour, any potato flour, montina, mesquite, buckwheat, chickpea, nut flour, arrowroot, dehydrated potatoes, corn meal, white beans and/or any other beans, garbonzo bean flour, sorghum flour, fava bean flour, corn, almonds, black beans, ground whole flaxseeds, golden flaxseeds, green pea flour, hazelnuts ground into flour, millet, amaranth, gluten free oat flour, rolled oats, Teff, quinoa flakes or any combinations of these.

It is an object of the present invention for the sugar to comprise brown sugar and white sugar. It is an object of the present invention for the cookies to further comprise gluten free vanilla, and/or honey, and salt.

### DETAILED DESCRIPTION OF THE INVENTION

A gluten free and/or casein free and dairy free cookie that is of the slice and bake cookie. In an embodiment, the cookie comprises chocolate dairy free chips. The chocolate chips may contain dairy for a gluten free only version.

The slice and bake cookie comprises: a flour mixture, baking soda, gluten free baking powder, xanthum gum, margarine (casein/gluten free), sugar, and eggs and salt. Butter or other gluten free shortening or oil may be used for gluten free only versions.

In an embodiment the flour mixture comprises: white rice flour, potato starch, tapioca flour, or any combination. In an embodiment, the flour mixture further comprises xanthum gum.

In an embodiment, the sugar comprises brown sugar and white sugar. In an embodiment, the cookies further comprise gluten free vanilla.

In an embodiment, the flour Mixture is made by combining the following in a separate bowl: approximately 2 cups white rice flour, approximately ⅔ cup potato starch, approximately ⅓ cup tapioca flour, and approximately 1 teaspoon xanthan gum.

Approximately 2¼ cup of flour mixture is used for the cookies.

The flour mixture is then combined with approximately 1 teaspoon of baking soda, approximately 1 teaspoon baking powder (gluten free), and approximately ¼ teaspoon of xanthan gum.

Combined separately in a mixer is approximately ¾ cup of margarine (casein/gluten free), approximately ¾ cup brown sugar, approximately ½ cup sugar, approximately 2 eggs, and approximately 2 teaspoons of gluten free vanilla and ½ tsp of salt. For gluten free only versions, butter or other gluten free oil or shortening may be used.

These ingredients are mixed well. The dry ingredients are added a little at a time to the mixer until thoroughly combined.

In a further embodiment, other ingredients to be used are peanut butter or any nuts added, gluten free oatmeal, raisins or any fruit, or fruit puree, sprinkles, frosting or icing or candy.

In an embodiment of the invention, any or all the ingredients may or may not be organic.

In an embodiment of the invention, the ingredients may contain enriched fiber.

In an embodiment of the invention, the product of the present invention may have B-complex vitamins, or iron, preservatives, artificial colors, egg, soy, hydrogenated oils, artificial sweeteners, yeast, lemon juice, vinegar or honey.

What is claimed is:

1. A slice and bake cookie comprising:
a flour mixture;
baking soda;
gluten free baking powder;
xanthum gum, arrow root starch, guar gum, corn meal, corn starch, corn, potato, potato starch, gelatin powder, lecithin, tapioca, tapioca starch, or any combination;
margarine (casein/gluten free), apple sauce, other fruit purees, shortening oils which are gluten free and/or casein free; butter for gluten free only version, palm oil, coconut oil, palm fruit oil, soy bean oil, olive oil, canola oil, grapeseed oil, or shortening or oils or any combination;
sugar and eggs, applesauce or fruit puree or any combinations thereof.

2. The cookie of claim 1 wherein said cookie is gluten free.

3. The cookie of claim 1 wherein said cookie is gluten free and/or casein free and dairy free.

4. The cookie of claim 1 wherein said cookie further comprises chocolate chips, dairy free for dairy free version or with dairy for gluten free only version.

5. The cookie of claim 1 wherein said flour mixture to comprises white rice flour, or any rice flour, potato flour, potato starch, tapioca flour, potato starch flour, montina, mesquite, buckwheat, chickpeas, dehydrated potatoes, cornmeal, any nut flour, arrow root, white beans and/or any beans, Teff, garbanzo bean flour, sorghum flour, fava bean flour, corn, almonds, black beans, ground whole flaxseeds, golden flaxseeds, green pea flour, hazelnuts ground into flour, millet, amaranth, gluten free oat flour, rolled oats, quinoa flakes, or any combination of the above.

6. The cookie of claim 4 wherein said flour mixture further comprises xanthum gum, arrow root starch, guargum, corn starch, potato starch, corn meal, or any combination.

7. The cookie of claim 1 wherein said sugar comprises brown sugar and white sugar.

8. The cookie of claim 1 further comprising gluten free vanilla or any honey.

9. A process for making a slice and bake cookie comprising:
combining white rice flour, potato starch, tapioca flour, and xanthum gum into a flour mixture;
combining said flour mixture with baking soda, baking powder (gluten free), and xanthum gum to form dry ingredients;
placing in a mixer margarine (casein/gluten free), brown sugar, white sugar, eggs, and gluten free vanilla and salt;
mixing said ingredients in said mixer;
adding said dry ingredients to said mixer until thoroughly combined; forming a cookie dough.

10. The cookie of claim 1 wherein said cookie can be consumed more safely by individuals with diagnoses such as Autism Spectrum Disorders, with food sensitivities, children with attention difficulties, celiac disease and wheat intolerances, as well as dairy intolerances.
